(19) United States
(12) Patent Application Publication
(10) Pub. No.: US 2006/0110082 A1
(43) Pub. Date: May 25, 2006

(54) COMPACT UNITIZED CRADLE SWASHPLATE BEARING

(75) Inventor: Jaromir TVARUZEK, Povazska Bystrica (SK)

Correspondence Address: ZARLEY LAW FIRM P.L.C., CAPITAL SQUARE, 400 LOCUST, SUITE 200, DES MOINES, IA, 50309-2350, US

(73) Assignee: SAUER-DANFOSS INC., Ames, IA (US)

(21) Appl. No.: 11/163,749

(22) Filed: Oct. 28, 2005

Related U.S. Application Data
(60) Provisional application No. 60/630,792, filed on Nov. 24, 2004.

(51) Int. Cl. F16C 32/02

(52) U.S. Cl. 384/2

(57) ABSTRACT

A roller bearing assembly for a variable displacement hydrostatic unit. The roller bearing has an inner race and an outer race with a cage therebetween that holds a plurality of rollable elements. A link is mounted to the inner and outer race such that the link is able to limit the arcuate movement of the cage element.

### CROSS REFERENCE TO A RELATED APPLICATION

This application is based upon Applicants' Provisional Application Ser. No. 60/630,792 filed Nov. 24, 2004.

### BACKGROUND OF THE INVENTION

This invention is directed toward a roller bearing for supporting a tiltable swashplate of a variable displacement hydraulic unit and more specifically to a timing mechanism to prevent slipping between a support housing and the tiltable swashplate.

Axial piston variable displacement hydraulic units are well known in the art and have a tiltable swashplate to control the displacement of pistons within a rotating cylinder block. One common type of tiltable swashplate is a cradle type swashplate which is supported at one end of the housing by an arcuate bearing having roller elements. Common roller bearing practice requires that the arcuate displacement of the roller bearing cage be one half of the arcuate displacement of the cradle swashplate in order to obtain an exclusively rolling motion of the roller elements. Furthermore, since the roller bearing is arcuate, but not totally circular, repeated tilting of the swashplate can lead to slipping of the roller elements between the housing and the cradler swashplate to positions other than the desired optimum support positions for resisting the axial thrust of the swashplate.

In order to assure that the roller bearing does not slip to an adverse position, various methods have been employed. For example, U.S. Pat. No. 4,627,330 by Beck, Jr. used a link secured between the housing and the swashplate. Several problems exist when utilizing the Beck, Jr. link. For example, the assembly of the device is complicated in that it requires the assembly of many loose parts and the alignment of the swashplate, the cage, and the housing. Further, the timing linkage disclosed in Beck, Jr. requires space in the housing to accommodate the link member which in turn requires a housing of greater length.

Therefore, a principal object of the present invention is to provide a roller bearing with an improved timing mechanism that improves upon the state of the art.

Another object of the present invention is to provide a roller bearing that is cost effective to manufacture and assemble.

A further object of the present invention is to provide a bearing that will reduce load on the swashplate.

Yet another object of the present invention is to provide a bearing that will simplify the amount of parts used by the bearing.

Yet another object of the present invention is to provide a timing mechanism that minimizes the amount of space needed in the housing to accommodate the mechanism.

A still further object of the present invention is to provide a timing mechanism that is easy to assemble.

### BRIEF SUMMARY OF THE INVENTION

A roller bearing assembly for a variable displacement unit having a swashplate. The roller bearing assembly has an inner race, an outer race, and a cage with a plurality of rollers positioned between the inner and outer races. The inner race has an inner race mounting pin, the outer race has an outer race mounting pin, and the cage has a cage pin. The bearing assembly has a link that has a hole that receives the outer race pin and an elongated slot that receives the inner race pin and cage pin such that the link is able to limit the actuate movement of the cage as compared to the variable displacement unit swashplate.

### BRIEF DESCRIPTION OF THE DRAWINGS

FIG. 1 is a sectional view of a hydraulic unit utilizing a bearing assembly;

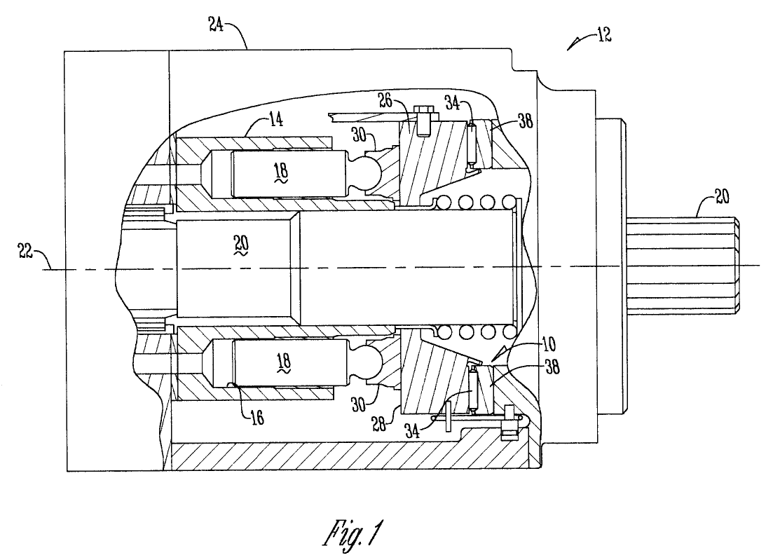

FIG. 2 is a perspective view of a roller bearing assembly;

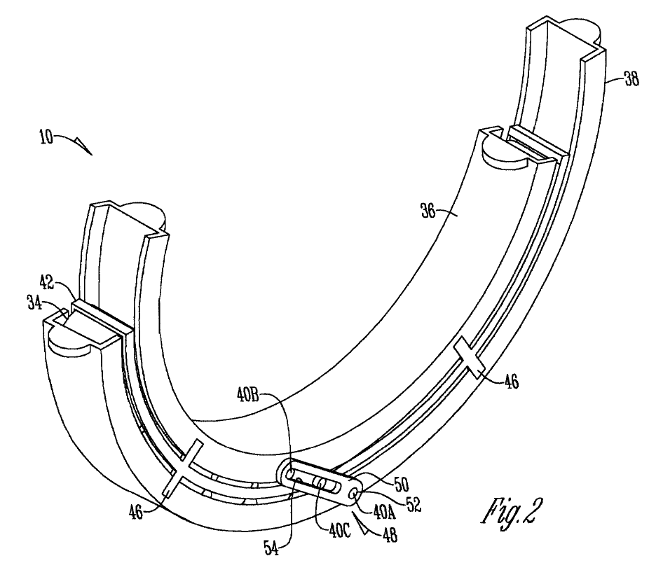

FIG. 3 is a perspective view of a roller bearing assembly without an inner race; and

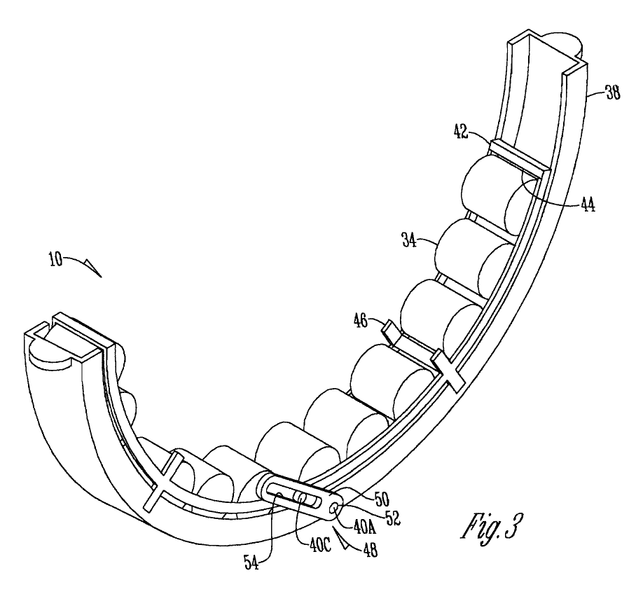

FIG. 4 is a side plan view of a roller bearing assembly on a swashplate of a variable displacement unit.

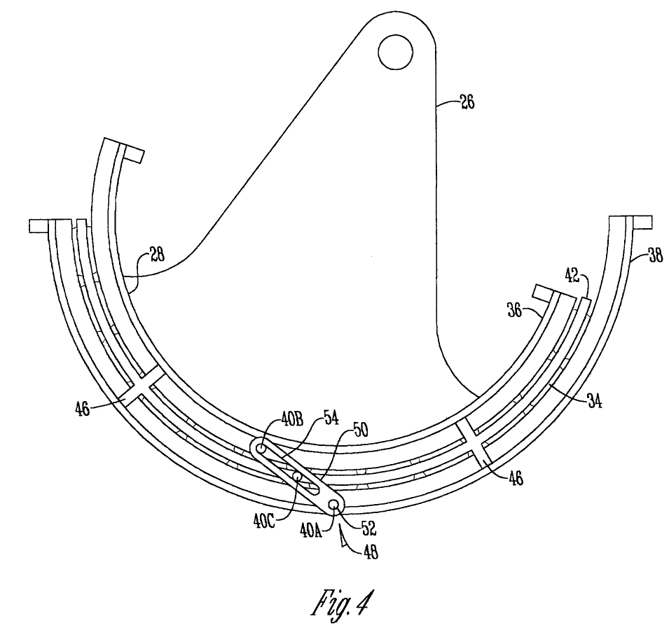

### DETAILED DESCRIPTION OF THE PREFERRED EMBODIMENT

The roller bearing assembly 10 is used in a variable displacement hydraulic unit 12. The hydraulic unit 12 may be either a pump or a motor and has a rotatable cylinder block 14 with a plurality of cylinder bores 16 with reciprocating pistons 18 therein. The cylinder block 14 is secured to a shaft 20 and rotates about a central axis 22. Located at one end of a housing 24 is a cradle swashplate 26 which is adapted for tilting or pivotal movement. The swashplate 26 has a planar cam surface 28 engaged by piston slippers 30 so that the tilting movement of the swashplate 26 controls the axial displacement of the pistons 18.

The cradle swashplate 26 is mounted on the housing 24 by a roller bearing assembly 10. The roller bearing assembly 10 has a plurality of rollable elements such as rollers 34 positioned between an inner race 36 and an outer race 38. The inner race 36 engages the arcuate surface 28 of the swashplate 26 while the outer race 38 is secured to arcuate portions of the housing 24 by pins 40a, 40b, 40c.

To maintain arcuate spacing between individual rollers 34, the bearing assembly 10 preferably has a retainer 42 which acts as a cage for the respective rollers 34. The retainer 42 has a plurality of slots 44 that arcuately locate the individual rollers 34. The inner race 36, cage 42, and outer race 38 are held together by a plurality of tabs 46 positioned anywhere along the assembly 10.

Desirable is that the retainer or cage 42 be one half the relative movement of the supported parts. Thus, in a cradle swashplate environment, such as in the present invention, it is desirable that the cage 42 be limited to arcuate movement that is one half the arcuate movement of the swashplate 26. This arcuate movement is controlled by a timing mechanism 48.

The timing mechanism 48 can take many forms, but preferred is an elongated link 50 that is mounted to the inner race 36 at one end and the outer race 38 at the opposite end. More specifically, the inner race 36, the cage 42, and the outer race 38 have mounting pins 40a, 40b, 40c that extend outwardly therefrom. The elongated link 50 has a hole 52 at one end that receives the outer race pin 40a and an elongated slot 54 that extends along the center of the link 50 and receives the inner race pin 40b and the cage pin 40c.

In operation, as the swashplate 26 tilts or pivots on the roller bearing assembly 10, the relative movement of the inner race 36 causes the link 50 to pivot about the outer race pin 40a, while the inner race pin 40b and the cage pin 40c slide within the slot 44 until the inner race pin 40b reaches the end of the slot 44 and thus restricts the inner race 36 and cage 42 from further rotational movement. Accordingly, the link 50 maintains alignment between the inner race 36 which moves relative to the swashplate 26, the cage 42, and the outer race 38 which is secured to the housing 24. The timing between the three elements is determined by the spacing between the inner race pin 40b, the cage 42, and the outer race pin 40a.

What is claimed is:

1. A roller bearing assembly used in a variable displacement unit, comprising;
an inner race;
an outer race;
a cage having a plurality of rollers positioned between the inner race and the outer race; and
a link mounted to the inner race and the outer race.

2. The roller bearing assembly of claim 1 wherein the inner race has an inner race mounting pin; the outer race has an outer race mounting pin; the cage has a cage pin; and the link has a hole that receives the outer race pin and an elongated slot that receives the inner race pin and the cage pin such that the link limits the arcuate movement of the cage.
